(19) United States
(12) Patent Application Publication
(10) Pub. No.: US 2026/0125509 A1
(43) Pub. Date: May 7, 2026

(54) ARYLATED AND NON-ARYLATED FAT-BASED EPOXY POLYMERS

(71) Applicant: The United States of America, as Represented by the Secretary of Agriculture, Washington, DC (US)

(72) Inventors: HELEN N. LEW, WYNNEWOOD, PA (US); MASOUD KAZEM ROSTAMI, PHILADELPHIA, PA (US); RICHARD D. ASHBY, GLENSIDE, PA (US); XUETONG FAN, NORTH WALES, PA (US); VICTOR RYU, PHILADELPHIA, PA (US); KAREN WAGNER, AMBLER, PA (US)

(21) Appl. No.: 18/934,585

(22) Filed: Nov. 1, 2024

(51) Int. Cl. C08G 59/46; C08G 59/62

(52) U.S. Cl. CPC C08G 59/46; C08G 59/621

(57) ABSTRACT

Fat-based epoxy polymer compositions and curing agents are described. The polymers have antimicrobial and other unique properties excellent for a multitude of uses, especially as, fillers, sealants, protective coatings and fabric enhancers. The polymer compositions can be produced from biobased sources.

### FIELD OF THE INVENTION

The invention relates to novel arylated and non-arylated fatty acid-based epoxy polymer compositions and methods of preparing and using them.

### BACKGROUND OF THE INVENTION

Epoxy polymers constitute classes of adhesive, sealant, coating, and insulation materials utilized in various industries ranging from electronics manufacturing to food canning owing to their impressive resistance to electric discharge, heat, and chemicals, on top of their great processability and strong adhesion to various substrates. Owing to the impressive adhesion of epoxy polymers to various surfaces, they are utilized as thin film protective coating layers that prevent wood from getting damaged by water, mold or termites, and protect metallic surfaces from rusting, and unwanted interactions with food, beverages, caustic, and corrosive substances. Despite the resilient resistance of such polymeric coatings against corrosion and oxidation, they are often stiff and susceptible to bacterial fouling as such microorganisms can grow on and colonize their surfaces. To prevent bacterial fouling, various types of antibacterial agents have been incorporated into polymer design including essential oils, minerals, organic and metal-based nanomaterials, and most often quaternary ammonium compounds (QACs). Although QAC-carrying polymers are effective against various types of bacteria and prevent bacterial fouling, they suffer a serious disadvantage due to the ionic nature of their positively charged quaternary amine functional groups and the counter ions coming with them. These ionic substructures are interactive sites that can release and exchange their counter ions especially when in contact with aqueous solutions like beverages, or even moisture provided by exposure to food and skin sweat. This leaching of ions can be a problematic phenomenon where water resistance matters because the occurring release and exchange of ions gradually alters the composition of the polymer, making its properties, stability, and durability unpredictable. In addition, in some cases, the capture or release of ions may cause side effects or even toxicity for the user or the environment.

There thus exists an ongoing need to develop efficacious, green, and safe polymer compositions, which address issues found with those used today and are also cost-effective, sustainable, and easily adaptable for widespread use.

### SUMMARY OF THE INVENTION

Described herein in various embodiments are polymers with tunable properties having compositions which are derived from combining an epoxy resin with:
A epoxy polymer curing agent of structure I shown below

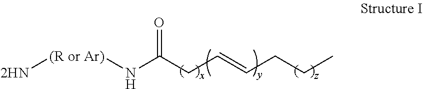

and,
a epoxy polymer curing agent of structure II shown below

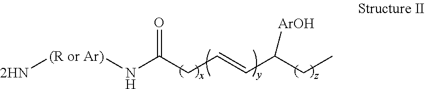

wherein x is 1-30 carbons, y is 0-10 cis or trans double bonds, and z is 0-30 carbons; and any of the carbons in x, y or z in structure II is substituted with an ArOH, wherein ArOH is an aromatic or a heteroaromatic ring system with at least one phenolic functional group; wherein the aromatic ring or heteroaromatic ring system is optionally substituted with one or more straight or branched alkyl, chlorine, fluorine, bromine, iodine, amino, nitro or thiol substituents; and
R or Ar are independently a polyamine aliphatic residue R which is branched or straight chain, substituted or unsubstituted, or a polyamine residue Ar which is substituted or unsubstituted.
The polymer compositions can include various ratios of curing agent structures I and II to each other in various embodiments of the polymers ranging from 1 to 99%.

Structure II exemplifies arylated polymer curing agents wherein the carbon chain is branched with one or more ArOH phenolic moieties having aromatic rings substituted with one or more substituents exemplified below: examples of one or more of ArOH phenolic moieties 1-5 whose structures are shown below

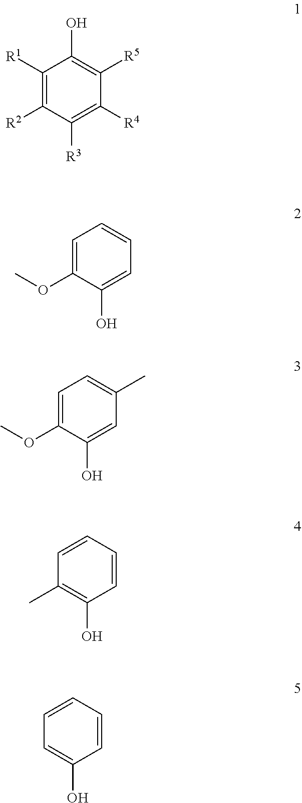

wherein R¹, R², R³, R⁴, and R⁵ groups in phenol 1 can be H, OH, halogen, nitro, thiol, amino, carbonyl, branched or linear chain alkyl groups, substituted or unsubstituted aliphatic, aromatic, or heteroaromatic rings containing one or more ring(s) with or without oxygen, nitrogen, sulfur or other atoms and one of R¹, R², R³, R⁴ or R⁵ is the point of ArOH connection to any of the carbons in x, y or z in a fatty amide chain in structure II. Phenols 2, 3, 4 and 5 are connected by any unsubstituted ring carbon atom to any of the carbons in x, y or z in a fatty amide chain in structure II wherein a ring hydrogen is replaced by the bond to any of the carbons in x, y or z in a fatty amide chain.

Described herein in various embodiments are methods of preparing polymers from epoxy resins and curing agents of structure I and II by (a) mixing structures I and II and an epoxy resin, optionally in a solvent at room temperature (rt); (b) solution casting, spraying and air-drying as needed; (c) hardening by thermal curing.

The polymer compositions described herein are used to improve substrates and enhance surfaces through waterproofing, inhibition of microbial growth and ambient damage.

### BRIEF DESCRIPTION OF THE DRAWINGS

FIG. 1 shows overlaid NIR spectra of exemplified polymers A-E slightly lifted for the sake of clarity.

FIG. 2 shows stacked FTIR spectra of exemplified polymers A-E.

FIG. 3 shows overlaid TGA (top) and stacked DSC (bottom) curves of exemplified polymers A-E.

FIG. 4 shows exemplified polymers A-E surface morphology screened by Scanning Electron Microscopy (SEM).

FIG. 5 shows stacked photographs of exemplified specimen objects designed and used herein.

FIG. 6 shows tables describing compositional makeup and mechanical properties of exemplified polymers.

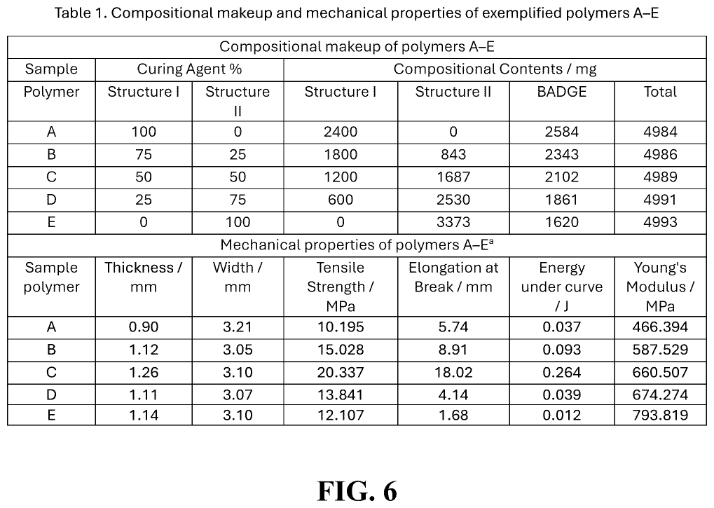

FIG. 7. shows a summary of antibacterial activity of example polymers.

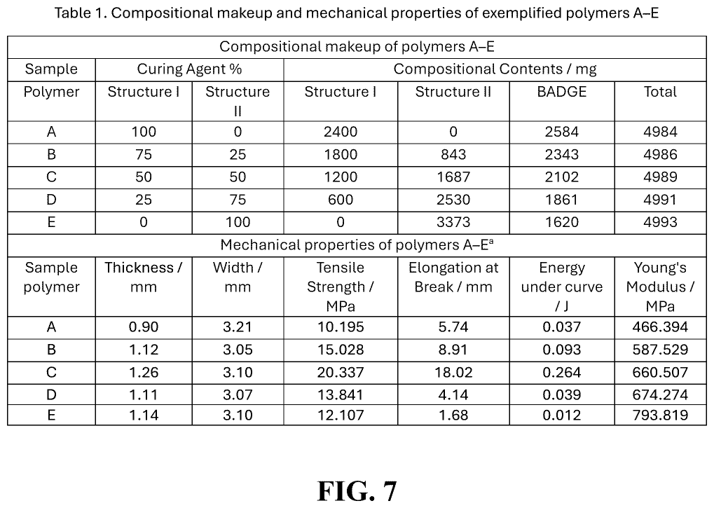

FIG. 8 describes a method of making curing agents from brown grease (BG).

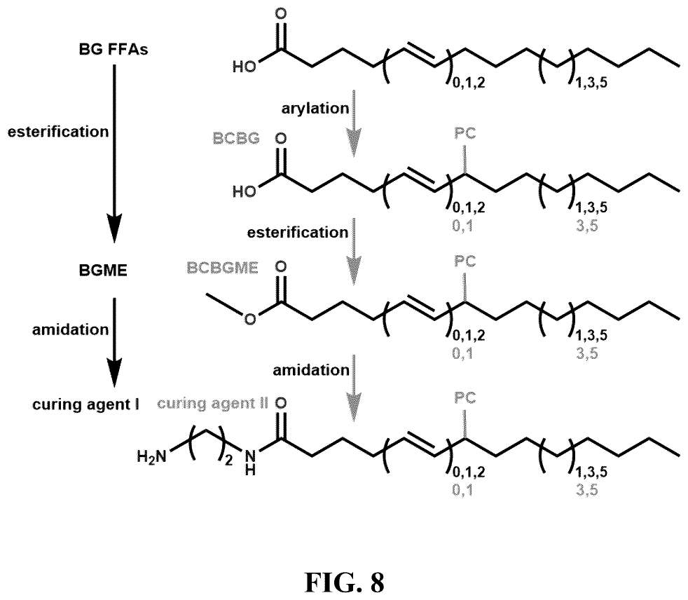

### DETAILED DESCRIPTION

Described herein are compositions and methods of making and using polymer compositions by combining curing agents and epoxy resins as follows:
a) A non-arylated epoxy curing agent of structure I shown below

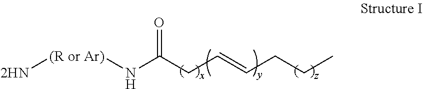

is combined with,
b) an arylated epoxy curing agent with one or more aryl groups with phenolic functional groups substituted on one or more carbons of the fatty amide shown below as structure II.

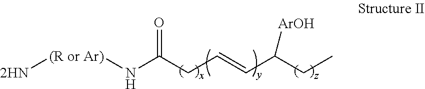

wherein x is 1-30 carbons, y is 0-10 cis or trans double bonds, and z is 0-30 carbons and any of the carbons in x, y or z in a fatty amide chain in structure II is substituted with an ArOH, wherein ArOH is a substituted or unsubstituted aromatic or heteroaromatic ring system with at least one phenolic functional group and the heteroaromatic ring system can contain one or more rings bearing heteroatoms including oxygen, nitrogen or sulfur, wherein the aromatic or heteroaromatic ring system is optionally substituted with one or more straight or branched alkyl, chlorine, fluorine, bromine, iodine, amino, nitro or thiol, substituent, and,
wherein, R or Ar is a polyamine residue which is a branched or straight chain, substituted or unsubstituted aliphatic or aromatic polyamine residue optionally bearing two or more primary, secondary or tertiary amine functional groups,
wherein the mixture of I and II is combined with
c) a polymerizable epoxy resin, diglycidyl-carrying bisphenol A (BADGE).

In various embodiments different ratios of curing agents of structures, I and II from 1% to 99% can be mixed with appropriate amounts of one or more epoxy resins to form various polymer compositions. For example, in some exemplified embodiments, a commercially available diglycidyl epoxy resin—namely, 2,2-Bis(4-glycidyloxyphenyl)propane or bisphenol A diglycidyl ether.

In one embodiment, a polymer is described with a commercially available diglycidyl epoxy resin wherein the epoxy resin is combined with a curing agent mixture wherein relative ratio of fatty amide curing agent of structure I to arylated fatty amide curing agent of structure II ranges between 99:1% to 1:99% wherein structures I and II curing agents are prepared from a fatty acid exemplified by oleic, palmitic or linoleic acid or mixtures thereof.

In one embodiment, a polymer is described with a commercially available diglycidyl epoxy resin wherein, the epoxy resin is combined with a curing agent mixture wherein relative ratio of curing agents is 1:3 so fatty amide curing agent of structure I is 25% to arylated fatty amide curing agent of structure II of 75%.

In one embodiment, a polymer is described with a commercially available diglycidyl epoxy resin wherein, the epoxy resin is combined with a curing agent mixture wherein relative ratio of curing agents is 1:1 so fatty amide curing agent of structure I is 50% to arylated fatty amide curing agent of structure II of 50%.

In one embodiment, a polymer is described with a commercially available diglycidyl epoxy resin wherein, the epoxy resin is combined with a curing agent mixture wherein relative ratio of curing agents is 3:1 so fatty amide curing agent of structure I is 75% to arylated fatty amide curing agent of structure II of 25%.

In one embodiment, a method of using a polymer as an antimicrobial agent with a commercially available diglycidyl epoxy resin is described, wherein the epoxy resin is combined with a curing agent mixture wherein relative ratio of fatty amide curing agent of structure I to arylated fatty amide curing agent of structure II ranges between 99:1% to 1:99%.

In one embodiment, a method of using a polymer as an antimicrobial agent with a commercially available diglycidyl epoxy resin is described, wherein, the epoxy resin is combined with a curing agent mixture wherein relative ratio of curing agents is 1:3 so fatty amide curing agent of structure I is 25% to arylated fatty amide curing agent of structure II of 75%.

In one embodiment, a method of using a polymer as an antimicrobial agent with a commercially available diglycidyl epoxy resin is described, wherein, the epoxy resin is combined with a curing agent mixture wherein relative ratio of curing agents is 1:1 so fatty amide curing agent of structure I is 50% to arylated fatty amide curing agent of structure II of 50%.

In one embodiment, a method of using a polymer as an antimicrobial agent with a commercially available diglycidyl epoxy resin is described, wherein, the epoxy resin is combined with a curing agent mixture wherein relative ratio of curing agents is 3:1 so fatty amide curing agent of structure I is 75% to arylated fatty amide curing agent of structure II of 25%.

In various embodiments, polymers and curing agents described above have phenolic-branches (ArOH) produced by reacting fatty acids and phenolic compounds described in U.S. patent application Ser. No. 16/999,142 (U.S. Pat. No. 12,012,369), to Huang et al incorporated herein by reference in its entirety. Fatty acids are synthetically or naturally sourced from vegetable oils, animal fats, and waste greases in various embodiments.

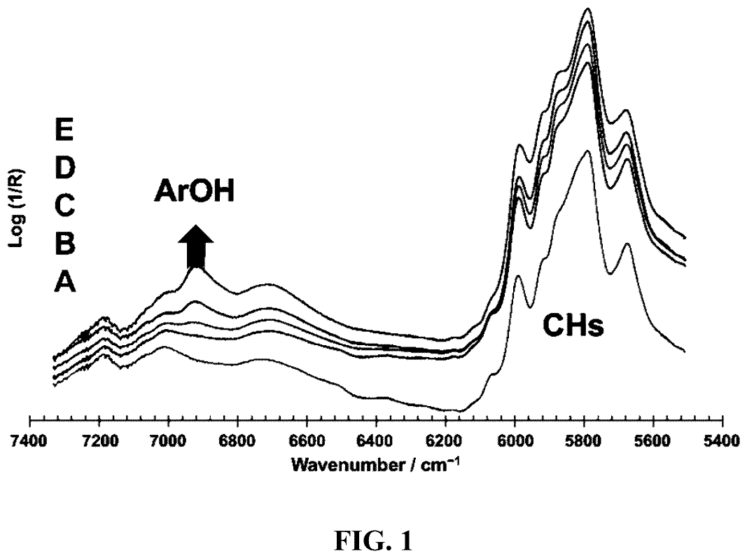

In various embodiments, phenolic compounds used for preparing the precursors of structure II type curing agents can be neat (a single aromatic compound bearing at least a phenol functional group) or a mixture of either natural or synthetic mono- or polyphenols obtained from herbal extracts, biomass, and their distillates or derivatives. For example, in one embodiment, the aromatic rings bearing phenolic functional groups are natural phenolics, derived from beechwood creosote, exemplified herein as reacted with brown grease fatty acids before derivatization and polymerization with an epoxy resin for constituting polymers A-E in table 1 (FIGS. 1-5).

In various embodiments the relative ratio of non-arylated and arylated curing agents of structures I and II vary in the range of 1 to 99% to one another and the curing agent mixture is reacted with a diglycidyl epoxy resin to provide polymer compositions exemplified by those labelled A-E in Table I.

In various embodiments, structures I and II coexist in resulting polymer in various ratios ranging from 1 to nearly 100% depending on the ratio of used non-arylated to arylated curing agents of structures I and II. For example, herein 25, 50, and 75% arylated to non-arylated monomer ratios resulted in exemplified polymers B, C, and D, respectively (table 1).

In one embodiment the curing steps and conditions to prepare the polymers are: (a) mechanical mixing of all ingredients at room temperature (rt) with or without other additives; (b) pouring or casting; (c) hardening by prolonged resting or by thermal curing at temperatures above ambient temperature.

In various embodiments the curing steps and conditions to prepare the polymers are: (a) mixing all ingredients with or without additional additives, e.g. natural or artificial dyes or pigments, at room temperature (rt) for few minutes, optionally in a volatile solvent(s), such as paint thinners, chloroform, ethyl acetate or propanol etc; (b) brush painting, printing, spin- or spray-coating or solution casting; (c) air-drying (d) hardening by exposure to heat or hot air.

In one embodiments the curing steps and conditions to prepare the polymers are: (a) mixing all ingredients at room temperature (rt) for few minutes with or without solvent(s); (b) adding particles including but not limited to natural or artificial particles, powdered minerals, sand, nanomaterials, metal shavings, chipped wood, rock, shredded rubber or plastics, biomass like ground plant-based material like saw dust, shredded paper, husk, bran or coffee grinds etc., (c) thermal curing in heated and pressurized molds for gluing or binding particles together and transforming them into composites with desired properties, shapes and geometries.

In one embodiment the curing steps and conditions to prepare the polymers are: (a) mixing each ingredient in a solvent in separate containers to prevent reactions and increase pot life; (b) gradually but continuously mixing solutions just before application for example spraying or spin coating them on surfaces and objects; (c) air-drying at rt; (d) hardening by thermal curing at a temperature above ambient temperature.

In one embodiment the curing steps and conditions to prepare the polymers are: (a) mixing all ingredients at room temperature (rt) in a solvent; (b) dipping objects, fabrics, garments, natural and synthetic fibers, leathers, yarns into the polymerization reaction solution; (c) air-drying them; (d) optionally repeating the dipping and air-drying steps as needed for thicker and multilayer coatings; (e) hardening the polymer layer(s) with thermal curing at a temperature above ambient temperature.

In one embodiment the curing steps and conditions to prepare the polymers are: (a) mixing at room temperature (rt); (b) solution casting and air-drying at rt; (c) hardening by prolonged storage or heating.

In various embodiments, the polymer compositions described here are used as surface coatings in domestic, industrial, medical or other similar environments to inhibit growth of pathogenic microorganisms, rusting and water damage.

In one embodiment, the polymer compositions described herein are used for medical devices and personal protective equipment (PPE) resistant to bacterial infestation, stains and dirt.

In various embodiments, the polymer compositions described herein are used for coating textiles, fabrics, protective covers and garments making them water- and windproof, lint-free, resistant to stains, dirt, and bacterial infestation.

In various embodiments, the nitrogen of the amide functional group in curing agents I and II described above is derived from aliphatic or aromatic amines reacted with a fatty acid to form an amide. The R or Ar is a residue or group formed by reacting amines exemplified by but not limited to bis(aminomethyl)cyclohexanes, ethylenediamine (EDA), diethylenetriamine (DETA), triethylenetetramine (TETA), tetraethylenepentamine (TEPA), spermidine, spermine, putrescine, cadaverine, hexamethylenediamine (HDA), xylylenediamines, and their analogs or derivatives.

The amide of the arylated curing agent structure II is exemplified by the compound below:

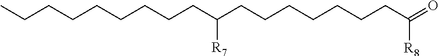

wherein R7 is a aromatic substituent with a phenolic group (e.g., simple phenol, creosote, thymol, or carvacrol/phenols of structure 1 to 5 above) and wherein R8 is a amide formed from reacting a fatty acid with a polyamine (exemplified by, ethylenediamine (EDA), diethylenetriamine (DETA), triethylenetetramine (TETA), tetraethylenepentamine (TEPA), hexamethylenediamine (HDA); etc.) reacted with the precursor fatty acid of structure II (for example oleic acid) to form the corresponding amide.

The amide of the non-arylated curing agent structure I is exemplified by the compound below:

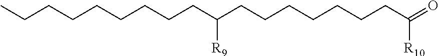

wherein R9 is a hydrogen and wherein R10 is a amide formed from reacting a fatty acid with a polyamine (exemplified by ethylenediamine (EDA), diethylenetriamine (DETA), triethylenetetramine (TETA), tetraethylenepentamine (TEPA), or hexamethylenediamine (HDA), etc.) reacted with the precursor fatty acid of structure I (for example oleic acid) to form the corresponding amide.

In various embodiments, the exemplified polymer compositions shown as specimen A-E (Table 1) having a 1 mm thickness and 3 mm width exhibit tensile strengths between 10 and 25 MPa, elongation at break/mm range of about 1 to 20, energy under curve/J of 0.01 to 0.27 and Young's Modulus of 466 MPa to 795 MPa (Table 1).

In various embodiments an object made from the polymers described herein has physical property ranges exemplified by tensile strength of about 5 to 50 MPa, elongation at break/mm range of about 2 to 300, energy under curve/J of about 0.02 to 0.40 and Young's Modulus of 250 MPa to 1000 MPa.

In various embodiments an object made from the polymers described herein has physical property ranges exemplified by tensile strength of about 10 and 25 MPa, elongation at break/mm range of about 5 to 200, energy under curve/J of 0.04 to 0.27 and Young's Modulus of 466 MPa to 795 MPa.

In various aspects, the polymer products are used as fillers, insulators, binders, or adhesive components.

In various embodiments, the curing agents of structures I and II are derived from one single or mixtures of synthetic or natural C2-C40 saturated or unsaturated, branched or straight chain carboxylic or fatty acid(s).

In various embodiments, the curing agents of structures I and II are derived from one or more carboxylic or fatty acids including but not limited to caprylic acid, capric acid, lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid or docosahexaenoic acid, and their analogs or derivatives.

In various embodiments, the curing agents of structures I and II are derived from derivatives of the above mentioned carboxylic or fatty acid(s) including their esters or anhydride, or acid chloride.

In various embodiments, the curing agents of structures I and II are derived from diamines or polyamines selected from but not limited to ethylenediamine (EDA), propylenediamines, methylenedianiline, diethylenetriamine (DETA), triethylenetetramine (TETA), tetraethylenepentamine (TEPA), phenylenediamine, xylylenediamine, spermidine, spermine, putrescine, cadaverine or hexamethylenediamine (HDA), their analogs and derivatives.

Exemplified polymers A-E herein are prepared with brown grease (BG) whose composition analysis revealed 73 wt % unsaturation and three major components namely oleic (C18:1, 51.5 wt %), palmitic (C16:0, 20.5 wt %), and linoleic (C18:2, 17.2 wt %) acids. In other embodiments, neat fatty acids or mixtures of them can be used for preparing various polymer compositions with various chain lengths and levels of saturation for differing their resistance to chemicals, oxidative attacks and mechanical properties.

In one embodiment, the phenolic residue of the arylated polymers of table 1 and their precursor compounds are derived from a mixture of phenolic compounds for example beechwood creosote.

Beechwood creosote exemplifies a mixture of monocyclic monophenols naturally obtained from wood distillation. Beechwood creosote batch used herein mainly consisted of guaiacol (28.1 wt %), xylenol (15.8 wt %), creosol (15.7 wt %), cresol (5.1 wt %). Other synthetically or naturally sourced phenols including but not limited to phenol, capsaicin, cardanol, eugenol, carvacrol, thymol, sesamol their analogs, and derivatives can be present and are also suitable.

Phenolic branched compounds of structure II and their precursors bearing carboxylic acid or ester groups are prepared by methods described in patent application Ser. No. 16/002,249 to Lew et al, U.S. Ser. No. 16/999,142 to Huang et al incorporated herein by reference in their entirety. Preparation of a phenolic-branched chain fatty acid (PBC-FA) by arylation of phenol with oleic acid using a modified H⁺ ferrierite zeolite catalyst (Fan, X., et al., J. Food Prot., 80 (1): 6-14 (2017); Ngo, H. L., et al., European J. of Lipid Sci. and Tech., 116 (3): 344-351 (2014); Yan, Z., et al., Industrial Crops and Products, 114: 115-122 (2018)), Kazem-Rostami, M.; Ryu, V.; Wagner, K.; Jones, K.; Mullen, C. A.; Wyatt, V.; Wu, C.; Ashby, R.; Fan, X.; Ngo, H., Antibacterial Agents from Waste Grease: Arylation of Brown Grease Fatty Acids with Beechwood Creosote and Derivatization. ACS Sustainable Chemistry & Engineering 2023, 11 (50), 17760-17768; are all incorporated herein by reference in their entirety.

In other embodiments, the ArOH groups may have more than one hydroxyl group like polyphenols or dihydric phenols; for example, catechol or resorcinol can be used with or without substituents including but are not limited to hydrogen, alkyl, alkoxy, phenyl, benzyl, halogen, nitro, thiol, thioether, disulfide, trifluoromethyl, carbonyl-carrying functional groups, or other aromatic or heteroaromatic ring containing one or more rings with oxygen, nitrogen, sulfur or other heteroatoms.

In other embodiments, the phenolic aromatic rings on the fatty acid chain of the polymers described herein can be heterocyclic or polycyclic, with substituents which are chiral or achiral, e.g. pyrenol, anthracenol, phenanthrol, chrysenol, binaphthol analogs and derivatives that enable additional properties including color, photoluminescence, axial chirality, optical activity and ultimately circularly polarized luminescence.

In various embodiments, arylated and non-arylated curing agents of structures I and II can cure epoxies and produce thermoset polymers. Thermosets are generally not soluble in organic solvents therefore withstand various chemicals and solvents. The resulting fat-based polymers are hydrophobic (i.e. repel water), and strongly bind onto various types of surfaces, substrates and fabrics to make them waterproof while maintaining flexibility.

In various embodiments, depending on the ratio of polymer to fabrics the saturation and permeability of the fabric can be tuned to make them windproof or breathable. These modified fabrics can resist against growth of bacteria, wrinkles, and stains (for example oil, wine, coffee, and blood etc.) making them useful candidates for the production of self-cleaning PPE, protective covers, and non-stick wound dressings serving as potential alternatives for perfluoroalkyl and polyfluoroalkyl substances (PFAS).

Described herein are, efficient yet simple and scalable methods for the utilization of bio-based polymers as fabric enhancers, obtained from arylated and non-arylated fatty amides, in the design of waterproof, lint-free, oil- and stain-resistant antimicrobial fabrics. The fabrics enhancers have potential uses in the production of wearable devices from backpacks to medical monitoring tools. Flat fabrics and objects like ordinary masks or aprons can be directly modified by their immersion in vats containing the polymerization starter solutions described earlier and cured by placing them between two silicone sheets and heating/ironing them. This heat not only cures the polymers but also sanitize/sterilize the fabrics making the abovementioned wound dressings ready to use. Depending on the application and substrate type, the curing temperature can be adjusted because the polymers cure at lower temperatures and withstand 300° C. Curved objects like garments, boots, shopping bags, backpacks and lab coats can be put on silicone-covered mannequins or molds before being sprayed with the polymerization solution and then cured by heat, respectively. Depending on the ratio of these enhancers to the fabrics, the resulting fabrics can be breathable or windproof as needed.

The methods of coating described herein in various embodiments can enhance various types of materials including but not limited to natural and synthetic fabrics (cotton, aramids like Kevlar, etc.), paper, carbon or glass fibers, etc. The enhanced fabric or paper can be waterproof and less permeable to gases and be used for garments, packaging and post-harvest crop protection, transportation and storage of goods. This coating can be done during or after the addition/application of known anti mold/mildew agents, insecticides, dyes or insect repellants, to contain and stabilize them. Aramids carbon fibers or fiberglass can be used instead of cotton to waterproof high-performance gear, wearable gadgets, protective covers and shields.

The versatile methods of coating described herein in various embodiments can enhance various natural and synthetic substrates, materials, and objects, including but not limited to fabrics, paper, glass, wood, metals, plastics, leather, etc. For example, coating wooden floors with such polymers can prevent termites damage on top of making the surfaces of waterproof and resistant to stains, microorganisms, mold and certain chemicals.

In various embodiments, depending on the application, fillers, plasticizers, reactive or nonreactive diluents can be utilized in the formulation to further tune the environmental and safety compliance, stability, production price, pot-life, thermal, mechanical, and dielectric properties of these polymers. Sand, sawdust, powdered minerals, nano particles or pigments can be added as fillers to obtain cost-effective composites with desired features.

In various embodiments, due to the excellent adhesion of these polymers onto surfaces like glass and their antimicrobial activity, they have potential uses as antimicrobial and antifog coatings for refrigerators, fish tanks, food packaging and storage devices, in addition to sanitation of publicly shared surfaces from supermarkets to airports, and the design of self-cleaned gears from kitchen utensils and hygienist paraphernalia to surgical tools and fillers.

In various embodiments, these bio-based and thermally stable polymers act as sealants to reduce the susceptibility of electrical devices, electronic components, cable junctions, coils, integrated and printed circuit boards to solvents, sparks and moisture.

In various embodiments, these polymers are employed as cementitious binders for affixing and binding chipped rocks, wood, rubber, fibers, and plastics. In this manner, minerals, biomass, synthetic wastes, and non-recyclables can be transformed into value-added artisan composites which are in demand as innovative and decorative construction alternatives to conventional flooring materials. Similarly, biomass can be mixed with these polymers and be transformed into disposable biodegradable utensils and containers.

In various embodiments, flat fabrics and ordinary aprons, bandages or masks are directly modified by their immersion in vats containing the polymerization starter solution containing epoxy resin and curing agents I and II and cured by placing them between two silicone sheets and heating/ironing them. Garments, shopping bags, backpacks and lab coats can be put on silicone-covered mannequins before being sprayed with or dipped in solutions of curing agents and epoxies and cured by heat.

Described herein are efficient yet simple and scalable methods for the utilization of bio-based products (polymerized arylated and non-arylated fatty amides) in the design of waterproof, oil- and stain-resistant antimicrobial enhanced fabrics. The enhanced fabrics have potential uses as nonstick wound dressings, self-cleaning PPE, protective covers, and wearable devices from backpacks to medical monitoring tools and military gear.

The exemplified polymers described herein in various embodiments are sustainable and sourced from biomass, mainly recycled waste grease and wood distillates, to help the environmental remediations. These products reduce demand and reliance on plastics, forever chemicals and crude oil products.

These polymers can make ordinary paper waterproof, antibacterial and non-permeable to gases. The coating compositions described herein produce enhanced paper material which can be used as brown bags, honeycomb wrapping, or packaging material to protect crops pre- and post-harvest.

The coating compositions described herein produce materials which can make various types of fabrics enhanced in their properties, for example natural cotton, waterproof and stain-resistant which can protect farmers, dentists, soldiers, nurses, surgeons, fishermen, slaughterhouse, and food processing facility workers from the elements including wind and rain, splashes of wastewater, blood and ultimately pathogens.

In various embodiments methods of preparing the coatings and compositions source starting materials from biomass including waste grease and wood distillates which are green, sustainable and have low prices. The methods of preparing the coatings and compositions simplify the procedures, avoid the use of rare, hazardous and expensive reagents, are developed methods for recovery and recycling of the unused ingredients, minimize the use of organic solvents and waste production, and designed so the production steps are scalable.

In various embodiments, methods of preparing a polymer are described comprising the steps of: arylating a unsaturated fatty acid with a phenolic compound; converting the fatty acid to a fatty amide by condensation with a polyamine to form a curing agent of structure II;

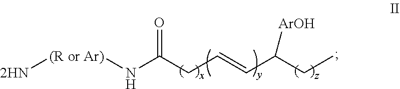

converting a fatty acid to a fatty amide by condensation with a polyamine to form a curing agent of formula I,

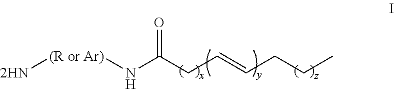

and reacting an epoxy resin with a mixture of curing agents of formula I and formula II.

In one embodiment of the method of preparing a polymer described above, the relative ratio of curing agent of structure I to curing agent of structure II ranges between 99:1% to 1:99%.

In one embodiment of the method of preparing a polymer described above, the fatty acid is first converted to a methyl ester before converting to a fatty amide of structure I or structure II.

In one embodiment of the method of preparing a polymer described above, the fatty acid is obtained from source selected from waste grease form a municipal waste, domestic or commercial waste source.

In one embodiment of the method of preparing a polymer described above, the phenolic compound is obtained from a biological source.

In one embodiment of the method of preparing a polymer described above, the relative ratio of curing agents is 1:1 so curing agent of structure I is 50% to curing agent of structure II of 50%. In one embodiment of the method of preparing a polymer described above, arylating a unsaturated fatty acid with a phenolic compound is a process heterogeneously catalyzed by ammonium ferrierite zeolite that covalently bonds the fatty acid to a phenol.

The compounds used in various embodiments may be prepared by techniques well known in organic synthesis and familiar to a practitioner ordinarily skilled in the art. However, these may not be the only means by which to synthesize or obtain the desired compounds.

The compounds may be prepared by techniques described in Vogel's Textbook of Practical Organic Chemistry, A. I. Vogel, A. R. Tatchell, B. S. Furnis, A. J. Hannaford, P. W. G. Smith, (Prentice Hall) 5th Edition (1996), March's Advanced Organic Chemistry: Reactions, Mechanisms, and Structure, Michael B. Smith, Jerry March, (Wiley-Interscience) 5th Edition (2007), and references therein, which are incorporated by reference herein. However, these may not be the only means by which to synthesize or obtain the desired compounds.

While the following terms in relation to the presently disclosed compounds are believed to be well understood by one of ordinary skill in the art, the following definitions are set forth to facilitate explanation of the presently disclosed subject matter. These definitions are intended to supplement and illustrate, not preclude, the definitions that would be apparent to one of ordinary skill in the art upon review of the present disclosure.

The term phenol (ArOH) herein describes a class of chemical compounds carrying one or more hydroxyl (—OH) functional group(s) bonded directly to an aromatic (Ar—) ring which can be in a larger aromatic system with other rings and can be heteroaromatic system atoms including nitrogen, sulfur or oxygen in heteroaromatic ring systems.

A functional group is a substituent or moiety in a molecule that causes the molecule's characteristic properties and reactivity.

The term “effective amount” of a composition, compound or property as provided herein is meant such amount is capable of performing the function of the compound or property for which an effective amount is expressed. As is pointed out herein, the exact amount required will vary from process to process, depending on recognized variables such as the compounds employed, and various internal and external conditions observed as would be interpreted by one of ordinary skill in the art. An appropriate effective amount may be determined, however, by one of ordinary skill in the art using only routine experimentation.

The amounts, percentages, and ranges disclosed herein are not meant to be limiting, and increments between the recited amounts, percentages, and ranges are specifically envisioned as part of the invention.

The term “optional” or “optionally” means that the subsequently described event or circumstance may or may not occur, and that the description includes instances in which said event or circumstance occurs and instances where it does not. For example, the phrase “optionally in a solvent” means that the composition may or may not need a solvent and that this description includes compositions that contain and do not contain a solvent.

In specific embodiments, narrower ranges of the amounts of each component may be desired for a particular use or characteristic in the final product.

The term “substantially pure” refers to a formulation that is at least about 90% (e.g., at least 90%) in purity weight/weight of a total composition. In a more preferred embodiment, the purity is at least about 95% (e.g., at least about 95%) weight-to-weight, or at least about 98% (e.g., at least about 98%) purity.

As used herein, the term “about” is defined as plus or minus ten percent of a recited value. For example, about 1.0 g means 0.9 g to 1.1 g.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicates otherwise.

It will be obvious to those skilled in the art that embodiments described herein are provided by way of example only. Numerous variations, changes, and substitutions will occur to those skilled in the art without departing from the embodiments of the claims. Various alternatives to the embodiments of the claims described herein may be employed in practicing the use of compositions and methods of treatment described herein. It is intended that the included claims define the scope of the various compositions and methods of treatment described herein and that methods and structures within the scope of these claims and their equivalents are covered thereby.

All publications, patents, and patent applications mentioned in this specification are herein incorporated by reference to the same extent as if each individual publication, patent, or patent application was specifically and individually indicated to be incorporated by reference.

The term “consisting essentially of” excludes additional method (or process) steps or composition components that substantially interfere with the intended activity of the method (or process) or composition. This term may be substituted for inclusive terms such as “comprising” or “including” to define any of the disclosed embodiments or combinations/sub-combinations thereof. Furthermore, the exclusive term “consist of” is also understood to be substitutable for these inclusive terms.

Fatty acid refers to an organic compound with at least one carboxylic acid group and a fully or partially saturated or unsaturated linear or cyclic carbon chain with or without other functional group(s). Stearic acid, linoleic acid, etc. are examples of fatty acids. Fatty acid amides (FAAs) are amides formed from condensing a fatty acid and an amine or ammonia; for example, hexadecanamide is the amide derivatives of palmitic acid and ammonia. The amine can be optionally substituted and be a polyamino compound such as ethylenediamine, diethylenetriamine, spermidine, etc.

A copolymer as used herein is also used to describe a compound which is a crosslinker, hardener or curing agent as they are widely known, promote cross-linking or curing of epoxy resins. Ratio of curing agents refers to the equivalent ratio of each curing agent/crosslinker/hardener compound to the other curing agent/crosslinker/hardener.

An arylated fatty amide curing agent or copolymer, is a fatty amide compound described herein which has an aromatic ring exemplified by the curing agents described herein exemplified by structure II.

Curing agent or curing process as used herein, refers to a compound that reacts with the functionality of one or more compounds present to form crosslinks between said one or more compounds in order to cure a polymer composition exemplified by various epoxy polymer compositions described herein. In some non-limiting embodiments, a epoxy polymer composition may be formed by molding and curing an epoxy resin composition.

As used herein, an “epoxy resin” is a resin consisting of monomers or short chain polymers with an epoxide group, i.e., a three-membered oxide ring, at either end. In an uncured stage, epoxy resins are polymers with a low degree of polymerization. They may be thermosetting resins that cross-link to form a three-dimensional non-melting matrix. A curing agent (hardener) is generally used to achieve the proper degree of polymerization.

Waste grease, brown grease, trap grease is a common side product of cooking and domestic, commercial and other forms of food production, whose accumulation often negatively impacts local municipalities and the environment.

As used herein, aromatic or “aryl” is intended to mean any stable monocyclic, bicyclic or polycyclic carbon ring of up to 10 atoms in each ring, wherein at least one ring is aromatic, and may be unsubstituted or substituted. One or more of the atoms in the carbon ring can be replaced by a nitrogen, oxygen or sulfur atom to form a heteroaromatic or heteroaryl or heterocyclic ArOH. Few examples of such aryl elements include but are not limited to: phenyl, p-toluenyl (4-methylphenyl), naphthyl, tetrahydro-naphthyl, indanyl, phenanthryl, anthryl or acenaphthyl, etc. In cases where the aryl substituent is bicyclic and one ring is non-aromatic, it is understood that attachment can be via the aromatic ring

As used herein, “derived from” refers to a derivative or a compound or composition that is derived from another compound by a chemical reaction to form a modified version of the original compound where one or more atoms or groups of atoms have been replaced, resulting in a new substance with potentially different properties. For example, a curing agent of structure II can be derived from linoleic acid by its reaction with a phenol and polyamine in separate reaction steps using suitable reagents and reaction conditions to form a desired product curing agent. Residue may refer to an atom or a group of atoms that form part of a molecule, such as a methyl group or an amine group. The later is exemplified in curing agent structures I and II wherein a amide is formed from reacting a fatty acid with a polyamine and structures I and II have a polyamine residue R or Ar.

As used herein, a “coating” refers to a material, or combination of materials, that form a substantially continuous layer or film on an exterior surface of a substrate, such as a textile or other surface.

As used herein, the term “textile” refers to a flexible woven or non-woven material consisting of a network of natural or artificial fibers often referred to as fabric, thread, or yarn. In an embodiment, a textile is cloth or fabric which can be used to fabricate clothing, shoes, bags, etc. In an embodiment, textiles can be used to fabricate carpeting, upholstered furnishings, window shades, towels, and coverings for tables, beds, and other flat surfaces. In an embodiment, textiles can be used to fabricate flags, backpacks, tents, nets, handkerchiefs, balloons, kites, sails, and parachutes

As used herein, tensile strength is the capacity of a material or structure to withstand tensile loads.

Elongation at break or elongation measures ductility of a material. It is often expressed as a percentage of the length at breakage relative to the initial length of the specimen.

Energy under curve/J refers to polymers tolerance for strain and stress before fracturing or deformation (for example permanent elongation) and is determined by integrating the area that falls underneath the energy absorption curve.

Young's modulus is a mechanical property that measures the stiffness or rigidity of a solid material, which may be determined from the stress-strain curve.

Three-dimensional object refers to an object that has three dimensions: length, width, and depth, meaning it occupies space and can be perceived with volume exemplified herein by an object made from a polymer composition, for example, a tool, device, article of clothing, utensil, etc.

Bio-based material as used herein is a material made, either wholly or partially, from substances derived from living (or once-living) organisms such as plants, animals, enzymes, and microorganisms, including bacteria, fungi and yeast.

Diamine or polyamine (denoted by R or Ar in various embodiments) linker refers to residue of an organic compound having at least two or more amine groups. Diamines are a commercially-important class of epoxy curing agents including both synthetic and natural amines often with ethylene (—CH₂CH₂—) linkages. Ethylenediamine, is the simplest exemplified member of such series of amines. Aliphatic, aromatic, saturated, unsaturated, multifunctional, cyclic and polycyclic amines can be employed in various embodiments of R and Ar polyamines. Useful diamines may be represented by the general formula R₁R₂N—R₅—NR₃R₄, wherein R₁, R₂, R₃ and R₄ are independently H or alkyl, and R₅ is a divalent alkylene or arylene. In some embodiments, R₁, R₂, R₃ and R₄ are each H and the diamine is a primary amine. In other embodiments, R₁ and R₄ are each H and R₂, and R₄ are each independently alkyl; and the diamine is a secondary amine.

DMA—dynamic mechanical analysis represents methods for the determination of parameters including but not limited to tensile strength, elongation at break, energy under curve, and Young's modulus.

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

As used herein, the word “exemplified or exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation. Unless defined otherwise, all technical and scientific terms used herein have the same meaning as commonly understood by one of ordinary skill in the art to which the invention belongs.

Although any methods and materials similar or equivalent to those described herein can be used in the practice or testing of the present invention, the exemplified methods and materials are now described.

### Examples

Having now generally described the compositions, methods of synthesis and other embodiments described herein, the same will be better understood by reference to certain specific examples, which are included herein only to further illustrate the embodiments and are not intended to limit the scope of the same as defined by the claims. Mention of trade names or commercial products herein is solely to provide specific information and does not imply recommendation or endorsement by the U.S. Department of Agriculture.

ACS-grade reagents and solvents were purchased and used without further purification unless otherwise mentioned. Crockmeter squares (straight-edged AATCC 50 mm crocking cloth, 100% cotton squares of 2″×2″) were supplied by Testfabrics Inc., PA and directly used in this work.

Brown Grease (BG) from Aggregated Trap Grease

BG matrix was first obtained through the rendering of aggregated trap greases, a two-step process that removes wastewater and solid residues by temperature-controlled settling, decanting and filtration. FFAs (Free Fatty Acids) were then separated from the BG (brown grease) matrix and purified by the utilization of wiped film evaporator (WFE). These initial purification steps, unlike chromatography techniques, require no organic solvents and can be done continuously and hence are readily scalable. BG FFAs were then thoroughly characterized and quantified by GC and HPLC instruments equipped with mass spectrometer (MS) and evaporative light scattering (ELS) detectors, respectively. The full characterization and profiling of BG FFAs indicated oleic (C18:1, 51.5 wt. %), palmitic (C16:0, 20.5 wt. %), and linoleic (C18:2, 17.2 wt. %) acids as three major components and revealed that the unsaturated FFAs makeup to 73 wt. % of the total. BG FFAs were then optionally subjected to arylation, (exemplified by) a process heterogeneously catalyzed by ammonium ferrierite zeolite that covalently bonds the FFAs to branched chain (BC's) natural monophenols.

Free Fatty Acid (FFAs) Separation from BG Matrix (BG FAAs)

BG matrix was fed to a short-path WFE (VKL 70-4-SKR/WRS-T, VTA, Germany) by an HPLC pump (Waters 515, USA) with a flow rate of 5 mL·min-1 at 60° C. WFE's cold trap was loaded with acetone and dry ice, and its wipers were set to rotate at 200 rpm under vacuum (<0.25 mbar) during the operation. WFE's wiping path and finger condenser were kept at 180 and 60° C., respectively. Distillation yielded distillates (BG FFAs, 57.8 wt. %), retentates and volatile residues captured by WFE's cold trap. BG FFAs sampled and examined by GC-FID, GC-MS, HPLC-MS-ELSD, NIR, FTIR and TLC Rf 0.2 (silica gel; tert-butyl methyl ether-hexanes, 10% v/v, AcOH 1%; TLC spots visualized by 5% ethanolic phosphomolybdic acid stain solution and heat). TAN: 196 mg KOH·g-1. IV: 90 gI2.100 g-1. FTIR (ATR, neat): 2924, 2853, 1708, 1281 cm-1.

### Synthesis of Methyl Ester Derivatives of BG FFAs (BGME)

Methanol (44 mL, 20 mol eq to FFA), H₂SO₄ (1.07 g, 98%, 20 mol % to FFA), and BG FFAs (15.04 g) were combined and refluxed at 70° C. for 2 h. The solution cooled down to r.t., reduced to 20% by volume at 40° C. using a rotary evaporator, neutralized by saturated NaHCO3 aqueous solution, and extracted with EtOAc. The organic layer was separated, rinsed twice with saturated NaCl solution, dried over Na2SO4, paper filtered and rotovaped at 55° C. until dry. This yielded 14.70 g of BGME as an amber color runny oil whose GC-MS analysis (Table S2) revealed the following composition: oleic acid (C18:1, 51.5 wt. %), palmitic acid (C16:0, 20.5 wt. %), linoleic acid (C18:2, 17.2 wt. %), stearic acid (C18:0, 4.8 wt. %), palmitoleic acid (C16:1, 2.8 wt. %), myristic acid (C14:0, 1.6 wt. %), and linolenic acid (C18:3, 1.5 wt. %). TLC Rf 0.7 (silica gel; tert-butyl methyl ether-hexanes, 10% v/v, AcOH 1%; TLC spots visualized by 5% ethanolic phosphomolybdic acid stain solution and heat). This product was also tested by GC-FID, HPLC-ELSD, NIR, and FTIR (ATR, neat): 2922, 2850, 1742, 1169 cm-1. TAN: below detection limit. IV: 85 gI2.100 g-1.

### Synthesis of EDA-Carrying BG or Brown Grease Fatty Amides (BGAM)

BGME (12.4 g) and EDA (28 g, excess) were combined and heated at 160° C. for 3 h under a slow stream of nitrogen. Reaction mixture was then rotovaped at 80° C. to remove the excess of EDA, cooled down to r.t., and divided between chloroform and DI water whose pH read around 8 after mixing. The organic layer was separated, rinsed with saturated NaCl aqueous solution, dried over Na2SO4, and rotovaped until dry. This resulted in BGAM as a yellowish waxy solid 9.8 g which was then analyzed by HPLC-MS-ELSD, and FTIR (ATR, neat): 3294, 2917, 2850, 1643, 1558, 1063 cm-1. TAN: below detection. IV: 77 gI2.100 g-1.

### Synthesis of BCBG by Arylation of BG FFAs

Stainless steel Parr reactor (600 mL) was loaded with BG FFAs (127.2 g), BC (320.4 g), and ferrierite zeolite catalyst (25.0 g), pressurized with nitrogen (40 psi) at r.t., its contents stirred for 1 min, and then vented. The reactor was then similarly repressurized, sealed, and its contents were stirred at 260° C. for 72 h. The reactor was then allowed to cool down to r.t., cautiously vented and let its contents pass through M-10 Ertel Alsop cellulose perlite filter (10 μm, nitrogen, 20 psi). The reactor, filtration apparatus and filter cake were rinsed thoroughly with EtOAc. EtOAc was then removed by rotary evaporation before combining the remaining residue with the main filtrate. This filtrate was then poured in a feed funnel and fed to WFE at 40° C. with a flow rate of 5 drops per min. WFE's cold trap was loaded with acetone and dry ice, and its wipers rotated at 200 rpm under vacuum (1-8×10-3 mbar) during the operation. WFE's internal condenser was kept at 40° C., while the wiping path was maintained at 90, 125, and 160° C. for stepwise stripping of excessive phenolics, removal of unreacted FFAs, and the final purification of BCBG, respectively. Unreacted BC recovered from WFE's cold trap weighed 245.0 g, 76.5%. Final retentate or crude beechwood creosote brown grease or arylated fatty acid product BCBG residue weighed 56.7 g, dispersed in EtOAc (300 mL), and passed through paper and then 0.45 μm PTFE filters. Filtrate was rotovaped at 45° C., then kept under high vacuum for 3 h. This resulted in 37.92 g of BCBG as an odorless dark brown viscous oil which was then analyzed by GC-MS, GC-FID, HPLC-ELSD-MSD, NIR and FTIR (ATR, neat): 3443, 2920, 2853, 1708, 1461, 1192 cm-1. TAN: 63 mg KOH·g-1.

### Synthesis of BCBG Methyl Ester (BCBGME)

BCBG (14 g) and methanol (500 mL) were mixed and passed through a 0.2 μm PVDF filter. The filtrate received H2SO4 (4 g, 98%) and stirred at 70° C. for 2 h. The solution cooled back to r.t., reduced to 20% by rotary evaporation, and neutralized with saturated NaHCO₃ solution. The mixture was extracted twice with EtOAc. The organic layers were combined, rinsed twice with saturated NaCl solution, dried over Na2SO4, paper filtered and rotovaped until dry. This resulted in beechwood creosote brown grease methyl ester product (BCBGME) as a dark brown oil 13.38 g which was analyzed by GC-MS, GC-FID, HPLC-ELSD, NIR and FTIR (ATR, neat): 3443, 2924, 2853, 1738, 1461, 1262, 1203 cm-1. TAN: below detection.

### Synthesis of Ethylenediamine (EDA)-Carrying Derivatives of BCBG Fatty Amides (BCBGAM)

BCBGME (11.44 g) and EDA (30 g, excess) were combined and refluxed at 160° C. for 3 h under a slow stream of nitrogen. The reaction mixture was rotovaped at 80° C. to remove the excess of EDA, cooled down to r.t., and divided between chloroform-dichloromethane (2:8) and DI water whose pH read at around 8 after mixing. The organic layer was separated, rinsed twice with saturated NaCl solution, dried over Na2SO4, paper filtered, rotovaped and then fully dried under high vacuum at r.t. within 3 h. This resulted in beechwood creosote brown grease amide (BCBGAM) as a tar-looking sticky substance 12.30 g which was then analyzed by HPLC-ELSD-MS, and FTIR (ATR, neat): 3301, 2920, 2853, 1647, 1463, 1268 cm-1. TAN: below detection.

Arylated and non-arylated epoxy curing agents of structures I and II were prepared by the amidation of arylated and non-arylated fatty acid methyl esters with ethylenediamine. These curing agents were weighed and mixed with diglycidyl-carrying bisphenol A (BADGE) in 25 mL of CHCl₃ at rt for 15 min. Each curing agent blend was solution cast in 8 glass 1-dram vials, 4 SEM stubs, 8 round- and 5 dogbone-shaped wells of the in-house built silicone molds, and the rest was applied on 4 precut pieces of cotton fabric squares, and allowed to air dry in a fume hood overnight before being thermally cured by baking them in a 120° C. oven for 2 h. SEM stubs and 1-dram vial respectively received 125 and 250 μL of the curing agent blend depositing approximately 25 and 50 mg of each polymer, taking a total volume of 2.5 mL of the blend or 500 mg of its dry ingredients. The round- and dogbone-shaped wells respectively received 750 and 2500 μL of the blended curing agent solution resulting in disks and dogbones with approximate weights of 150 and 500 mg, respectively. These specimens took a total of 18.5 mL of the blend or 3.7 g of its dry ingredients. Precut pieces of cotton fabric were simultaneously dipped in the remaining 4 mL of the blend, providing each with ˜200 mg of dry ingredients for uptake a total of 0.8 g of the blended curing agent. These cloth squares were then separately sandwiched between two silicone sheets to mimic ironing conditions during their thermal curing. The dogbones and films were manually extracted from the molds and visually inspected for defects including cracks and bubbles. Pristine (untreated) and modified (or treated) fabrics marked with a pencil and weighed. These weighed fabrics were then immersed in deionized water or canola oil at rt for 1 min, taken out and lightly padded with disposable paper towels before calculating the percentage of gained weight that stands for water or oil uptake. The mild antimicrobial activity and chemical inertness of these polymers prompted application on natural cotton fabrics and study their wettability and uptake by immersion in canola oil and water. Untreated cotton fabrics weighed 1.88-2.1 and 2.3-2.6 times heavier after immersion in deionized water and canola oil, respectively. In contrast, cotton fabrics treated with the polymers impressively weighed only 1-6% and 11-16% heavier after immersion in water and canola oil, respectively, which relate to the adsorption of the liquids rather than absorption. The fabrics were saturated with polymers to achieve a high resistance to water and oil for demonstration purposes.

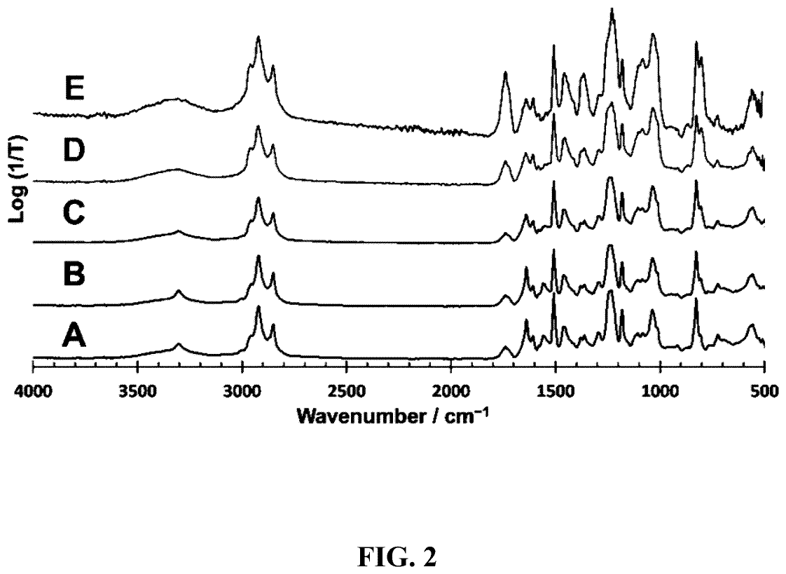

Infrared Spectroscopy: Thermo Antaris II analyzer equipped with integrating sphere and three-position card holding transmission modules recorded FT-NIR spectra between 10000-4000 cm⁻¹ frequencies with 4 cm⁻¹ spectral resolution (FIG. 1). FTIR Attenuated total reflection (ATR) accessory mounted on Bruker's Alpha Platinum was employed for recording 32 scans between 4000-400 cm⁻¹ with 8 cm⁻¹ spectral resolution (FIG. 2).

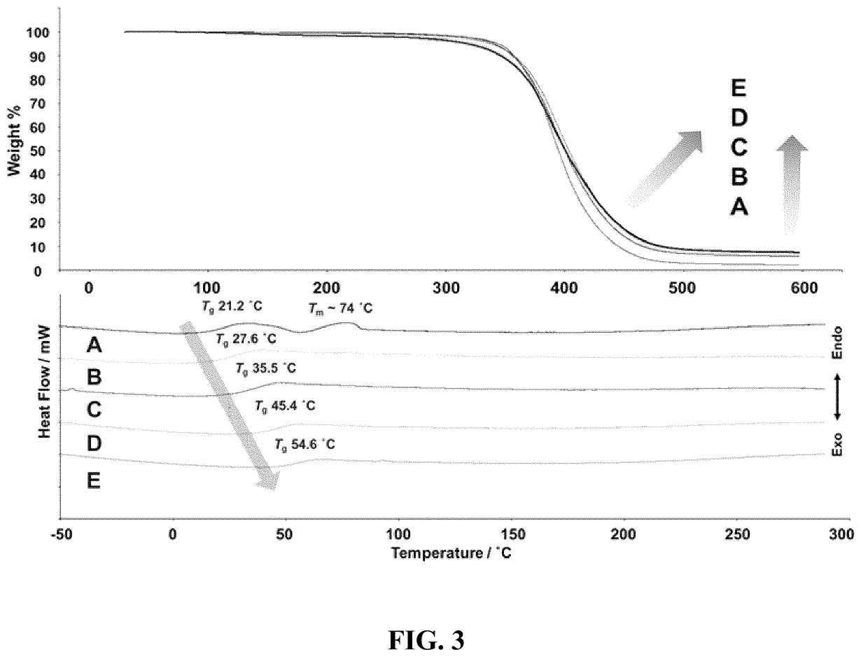

Thermolysis: PerkinElmer differential scanning calorimeter DSC8000™ and thermogravimetric analyzer TGA8000™ were employed for the thermal analyses of polymers A-E. The DSC samples were held at 25° C. for 5 min, then heated to 300° C. at 10° C./min rate and held at 300° C. for 5 min. These samples were then cooled down to −70° C. at 10° C./min and held at −70° C. for 5 min before heating them again up to 300° C. at 10° C./min while recording the DSC curves. TGA samples were placed in ceramic hooked pans (PerkinElmer P #: N5320103) and heated from 30 to 600° C. at 20° C./min under the stream of nitrogen gas with 40 mL/min flow rate (FIG. 3).

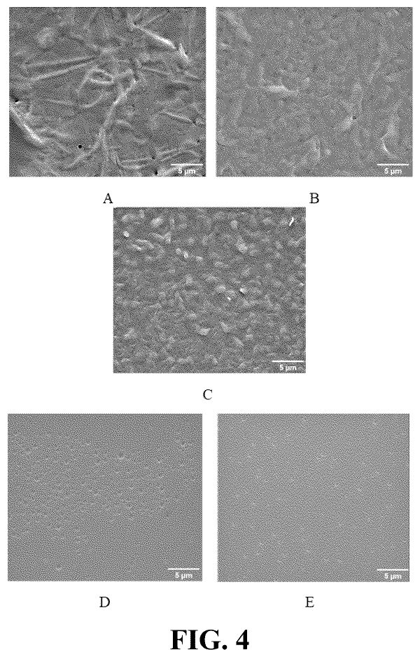

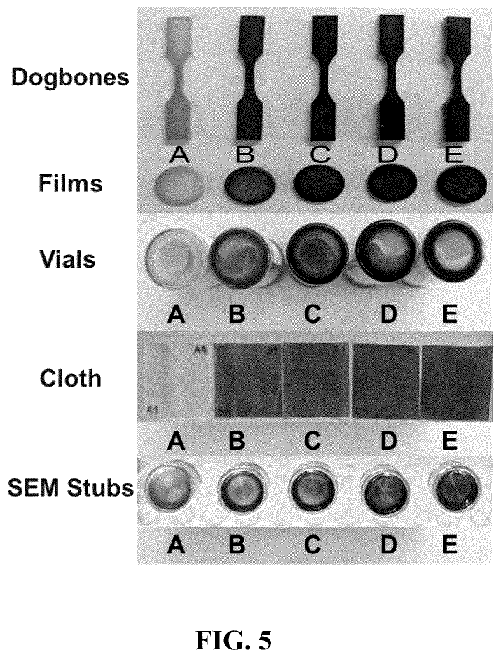

Specimen Preparation for Scanning Electron Microscopy (SEM): SEM stubs (Aluminum dish pin stub Ø12.7×7 mm, 1.5 mm dish depth, Rave Scientific, USA) coated with polymers A-E were rinsed with 100% ethanol before critical point drying (Denton Vacuum, Inc, NJ) using liquid carbon dioxide (Welco Co, Allentown PA) for approximately 20 min. The stubs were then sputter coated (EMS 150R ES, EM Sciences, Hatfield, PA) with gold for 1 min, before being viewed with an FEI Quanta 200 F Scanning Electron Microscope (Hillsboro, OR) with an accelerating voltage of 10 KV in high vacuum mode (FIGS. 4 and 5).

Mechanical Property Testing: Mechanical property testing was performed according to ASTM D638 using Type V-shaped specimens (FIG. 5). The edges of the specimens were ground down using a compact die grinder to remove any lips and flatten them before conditioning for 72 hours at 23±2° C. and 50±5% relative humidity. These conditioned specimens were then tested with a distance of 2.54 cm between the two grips and a strain rate (crosshead speed) set at 1 cm/min. The mechanical properties including tensile strength (MPa), elongation at break (%), and Young's Modulus (MPa) were measured using an Insight 5 and Testworks-4 data acquisition software (MTS Systems Corp., Minneapolis, MN).

Culturing and Antimicrobial Activity Studies: Antimicrobial activity of polymers A-E was examined in solution using 1 dram vials whose bottoms were coated with ˜50 mg of the polymers (FIG. 5). L. innocua Seelinger (ATCC-33090), E. coli O157:H7 (ATCC-700728), distilled water and 200-proof ethanol (64-17-5, Koptec, King of Prussia, PA, USA) were used for this study. These bacteria were stored at −80° C. in cryopreservative-containing cryovials (Microbank™ 2D, Pro-Lab Diagnostics, Roundrock, TX, US) on arrival and prior to use. One loopful of each frozen stock was inoculated in tryptic soy broth (TSB; 211825, BD Diagnostic Systems, Berkshire, UK) at 37° C. overnight to obtain working stocks used for experiments. These inocula were streak plated onto PALCAM Agar (222530, BD Diagnostic Systems) or MacConkey Sorbitol Agar (279100, BD Diagnostic Systems) to obtain isolated colonies which then were stored at 4° C. for two weeks. Colonies from these working stocks were inoculated into TSB and allowed to grow at 37° C. for 18 h. The incubated cultures were then diluted 1:10 for reading optical density of 0.14 cm⁻¹ or 0.15 cm⁻¹ at 600 nm (OD600), respectively, to obtain 9 log CFU/mL bacterial density. The cultures were rinsed with 0.1% peptone solution (218071-500 g, BD Diagnostic Systems) using centrifugation of 2182.3×g for 10 min. These washed cultures were serially diluted and spread-plated on Tryptic Soy Agar (TSA; 236920, Neogen) to confirm the bacterial density. The antimicrobial activity of polymers was determined by aliquoting 1 mL of diluted cultures with initial inoculum of 3 log CFU/mL of L. innocua or 2 log CFU/mL of E. coli in vials whose bottom was coated with the polymers A-E (FIG. 5) which was soaked and rinsed twice with 75% ethanol for 2 h and dried at 80° C. oven for 2 h prior to use. These vials were then incubated at 37° C. for 24 h before plating their top suspension (1 mL) on TSA plates and incubating at 37° C. for 24 h. The appearance of colonies on the plates indicated bacteria had survived the treatment and vice versa. The vials were then rinsed with 75% ethanol for 2 h and dried at 80° C. for 1 h prior to reusing them (Table 2).

Characterization of the specimen: Differential scanning calorimetry (DSC) and thermogravimetric analysis (TGA) both attested to the thermostability of the polymer compositions at elevated temperatures up to 300° C. It is noteworthy that the onset temperature of glass transitions (Tg) detected by DSC smoothly increased with the arylation ratio from 21° C. for non-arylated polymer A (table 1) to 55° C. for arylated polymer E (table 1). FTIR spectroscopy displayed overlapped and merged N—H and O—H stretching bands peaking at around 3303 cm⁻¹ whose pointy curvature became broader with the arylation due to the increasing involvement of the ArOHs hydrogen bonding interactions within the matrix. The peak consistently observed at around 1647 cm⁻¹ was assigned to amides C═O stretching, peaks 1610, 1509, and 1460 cm⁻¹ are mostly related to aromatic C═C stretching and in-plane N—H and C—H bending bands. Frequencies at 1243 and 1033 cm⁻¹ were assigned to alkyl aryl ether C—O stretching bands. NIR spectroscopic analysis of these polymers revealed a growing activity centered at around 6923 cm⁻¹, mainly displaying the first overtone of phenolic compounds' aromatic hydroxyl (ArOH) groups, increasing with the ratio of arylated curing agent. This peak appeared broader and at slightly lower frequencies than those observed in solution, i.e. 6938-7058 cm⁻¹, hinting at stronger NCIs (non-covalent interactions) occurring in the solid phase. These subtle differences were better visualized by overlying NIR absorption spectra of the arylated and non-arylated polymers. The comparison of these two indicated the emergence of ArOHs first overtone centering at around 6923 cm⁻¹, and a slightly decreased activity from 4900 to 5400 for arylated polymer. During initial assessments, the soft, semiductile, or leather-like texture of non-arylated polymer to be the quite opposite of the hard and brittle texture of the arylated polymer. The different blends of curing agents resulted in other polymers that displayed enhanced mechanical properties and characteristics. The stiffness of these polymers expressed by Young's modulus steadily increased with their arylation ratio from 466 MPa for non-arylated polymer to 793 MPa for fully arylated polymer. Interestingly, their tensile strength peaked at the mid-range arylation ratio. This polymer, composed of an equal relative ratio of non-arylated and arylated curing agents, showed the highest tensile strength, elongation at break, and energy under curve among all others, demonstrating a desirable combination of stiffness and stress tolerance has been achieved (Table 1).

The antibacterial activity of these new polymers was studied against Listeria innocua Seelinger (ATCC-33090), and Escherichia coli O157:H7 (ATCC-700728), as two common representatives of Gram-positive and -negative foodborne pathogens, respectively. Interestingly, the polymer that had the 1:1 ratio of the arylated to non-arylated curing agents displayed the highest activity against both microorganisms (Tables 1 and 2).

Morphological screening of surfaces of these polymers with scanning electron microscopy (SEM) was done. The recorded SEM images indicated the wrinkled-looking texture of non-arylated polymer becomes smoother with the increasing arylation ratio. (FIG. 4).

These polymers were applied on natural cotton fabrics and studied their wettability and uptake by immersion in canola oil and water. Untreated cotton fabrics weighed 1.88-2.1 and 2.3-2.6 times heavier after immersion in deionized water and canola oil, respectively. In contrast, cotton fabrics treated with the polymers impressively weighed only 1-6% and 11-16% heavier after immersion in water and canola oil, respectively, which relate to the adsorption of the liquids rather than absorption. The fabrics were saturated with polymers to achieve a high resistance to water and oil. (FIG. 5).

We claim:

1. A polymer composition comprising:
at least one curing agent of structure I 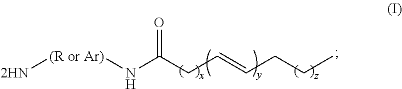
a least one curing agent of structure II 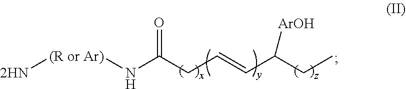
and
an epoxy resin;
wherein x is 1-30 carbons, y is 0-10 cis or trans double bonds, and z is 0-30 carbons; and any of the carbons in x, y or z in structure II is substituted with at least one ArOH, wherein ArOH is an aromatic or a heteroaromatic ring system with at least one phenolic functional group; wherein the aromatic ring or heteroaromatic ring system is optionally substituted with one or more straight or branched alkyl, chlorine, fluorine, bromine, iodine, amino, nitro or thiol substituents; and
R or Ar are independently a polyamine aliphatic residue R which is branched or straight chain, substituted or unsubstituted, or a polyamine aromatic residue Ar which is substituted or unsubstituted.

2. The polymer composition of claim 1 wherein the curing agent of structure I and structure II are derived from amidation with a polyamine of fatty acid, caprylic acid, capric acid, lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid or docosahexaenoic acid.

3. The polymer composition of claim 1 wherein the epoxy resin is 2,2-Bis(4-glycidyloxyphenyl)propane.

4. The polymer composition of claim 1 wherein the R or Ar residue of structure I or structure II is produced by reacting a fatty acid with polyamine ethylenediamine, diethylenetriamine, triethylenetetramine, tetraethylenepentamine, spermidine, spermine, putrescine, cadaverine or hexamethylenediamine.

5. The polymer composition of claim 1 wherein the ArOH aromatic or a heteroaromatic ring system is derived from a biobased source of phenolic compounds.

6. The polymer composition of claim 5 wherein ArOH is guaiacol, 2,3-xylenol, creosol, m-cresol, phenol, thymol or carvacrol or mixtures thereof.

7. The polymer composition of claim 1 wherein the heteroaromatic ring system contains one or more rings bearing one or more heteroatoms selected from oxygen, nitrogen or sulfur heteroatoms.

8. The polymer composition of claim 1 wherein, the relative equivalent ratio of curing agent of structure I to curing agent of structure II is between about 99:1% to 1:99%.

9. The polymer composition of claim 1 wherein, the relative equivalent ratio of curing agents of structure I to curing agent of structure II is about 1:3.

10. The polymer composition of claim 1 wherein, the relative equivalent ratio of curing agents of structure I to curing agent of structure II is 1:1.

11. The polymer composition of claim 1 wherein, the relative equivalent ratio of curing agents of structure I to curing agent of structure II is 3:1.

12. The polymer composition of claim 1 wherein a three-dimensional object comprising the composition of claim 1 has a tensile strength of about 5 to 50 MPa, elongation at break/mm range of about 2 to 300, energy under curve/J of 0.02 to 0.40 and Young's Modulus of 250 MPa to 1000 MPa.

13. The polymer composition of claim 1 wherein a three-dimensional object comprising the composition of claim 1 has a tensile strength of about 10 to 25 MPa, elongation at break/mm range of about 5 to 200, energy under curve/J of 0.04 to 0.27 and Young's Modulus of 466 MPa to 795 MPa.

14. A device, tool, or component; coated with the polymer composition of claim 1, wherein the coating kills or inhibits microorganisms, wherein said microorganisms are Gram-positive bacteria, Gram-negative bacteria, or a mixture thereof.

15. A method of inhibiting or killing microorganisms, said method comprising contacting said microorganisms with an effective amount of a polymer composition made by reacting:
at least one curing agent of structure I 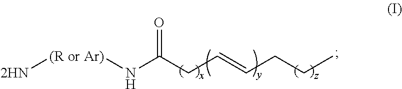
at least one curing agent of structure II 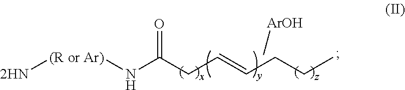
and
a diglycidyl epoxy resin
wherein x is 1-30 carbons, y is 0-10 cis or trans double bonds, and z is 0-30 carbons;
and any of the carbons in x, y or z in structure II is substituted with an ArOH, wherein ArOH is an aromatic or a heteroaromatic ring system with at least one phenolic functional group; wherein the aromatic ring or heteroaromatic ring system is optionally substituted with one or more straight or branched alkyl, chlorine, fluorine, bromine, iodine, amino, nitro or thiol substituents; and
R or Ar are independently a polyamine aliphatic residue R which is branched or straight chain, substituted or unsubstituted, or a polyamine aromatic residue Ar which is substituted or unsubstituted.

16. The method of claim 15 wherein the polymer composition is a coating on a fabric.

17. The method of claim 16 wherein the fabric is at least a portion of an apron, a bandage, or a mask.

18. The method of claim 15 wherein the polymer composition is a surface coating of a domestic, industrial, medical, or commercial environment.

19. The method of claim 15 wherein, the relative equivalent ratio of curing agent of structure I to curing agent of structure II ranges between about 99:1% to 1:99%.

20. The method of claim 15 wherein, the relative equivalent ratio of curing agents of structure I to curing agent of structure II is about 1:3.

21. The method of claim 15 wherein, the relative equivalent ratio of curing agents of structure I to curing agent of structure II is about 1:1.

22. The method of claim 15 wherein, the relative equivalent ratio of curing agents of structure I to curing agent of structure II is about 3:1.

23. A method of synthesizing a polymer comprising the steps of:
a. arylating a unsaturated fatty acid with a phenolic compound,
b. converting the arylated fatty acid to a fatty amide by condensation with a polyamine to form a curing agent of structure II, 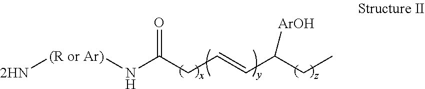
c. converting a fatty acid to a fatty amide by condensation with a polyamine to form a curing agent of formula I, 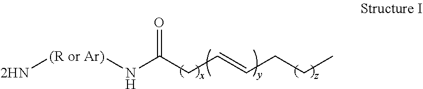
d. Reacting an epoxy resin with a mixture of curing agents of formula I and formula II.

24. The method of claim 23 wherein, the relative ratio of curing agent of structure I to curing agent of structure II ranges between about 99:1% to 1:99%.

25. The method of claim 23 wherein, the fatty acid is first converted to a methyl ester before converting to a fatty amide of structure I or structure II.

26. The method of claim 23 wherein, the fatty acid is obtained from source selected from waste grease from a municipal waste or commercial waste source.

27. The method of claim 23 wherein, the phenolic compound is obtained from a biological source.

28. The method of claim 23 wherein, the relative equivalent ratio of curing agents of structure I to curing agent of structure II is 1:1.
